(19) United States
(12) Patent Application Publication
(10) Pub. No.: US 2006/0099360 A1
(43) Pub. Date: May 11, 2006

(54) Dip, spray, and flow coating process for forming coated articles

(75) Inventor: Said Farha, Pleasantville, NY (US)

Correspondence Address: RYNDAK & SURI LLP, 200 W MADISON STREET, SUITE 2100, CHICAGO, IL, 60602, US

(73) Assignee: PepsiCo, Inc.

(21) Appl. No.: 10/983,149

(22) Filed: Nov. 5, 2004

(51) Int. Cl. B28B 11/00

(52) U.S. Cl. 428/34.4; 427/372.2

(57) ABSTRACT

Thermoplastic resin coated metal, ceramic, and glass articles are made by providing a metal, ceramic, or glass article, applying an aqueous solution, suspension, and/or dispersion of a coating material comprising a first thermoplastic resin to a coated or uncoated surface of the article substrate by dip, spray, or flow coating, withdrawing the article from the dip, spray, or flow coating at a rate so as to form a first coherent film, removing any excess material resulting from the dip, spray, or flow coating, and curing and/or drying the coated article until the first film is substantially dried so as to form a first coating, where the first thermoplastic resin comprises a thermoplastic epoxy resin. Additional coatings of similar or different compositions may be applied onto the first coating in successive iterations of the steps of the inventive process.

### BACKGROUND OF THE INVENTION

1. Field of the Invention

The invention relates to coated articles, such as containers. In particular, the invention is directed to coated articles, where the coatings provide improved protection from UV light and/or a reduced surface coefficient of friction to facilitate movement of the articles on a production line.

2. Discussion of the Related Art

Although plastic containers have replaced glass, ceramic, and metal containers in many applications, those materials are still widely used. Glass, ceramic, and metal have a number of advantages for use in containers. In particular, glass, ceramic, and metal containers provide a substantially impervious barrier to the diffusion of gases, such as carbon dioxide and oxygen into the container. In contrast, plastics typically have a substantial gas permeability that is a disadvantage in containers for carbonated beverages and oxygen-sensitive food. Most glass, of course, and certain ceramics are at least partially transparent to visible light, thereby allowing the contents to be observed by a consumer, and are also available in a variety of colors that vary from almost totally clear to opaque.

In transparent containers, transmission in the ultra violet (“UV”) region of the spectrum may be disadvantageous in certain applications, as UV radiation is known to degrade food and beverages. For this reason, beer, with few exceptions, is typically sold in cans or in green or brown glass bottles to reduce the potential for UV degradation. In addition, UV radiation may also bleach the painted or tinted surfaces of cans, jars, and bottles. As solar radiation is the main source of UV in the environment, the longer wavelengths of UV radiation that reach ground level without being absorbed by the atmosphere are the major concern, as exposure to shorter wavelengths is unlikely. Most UV radiation that reaches ground level is in the region known as UV-A, and has a wavelength of 320 to 400 nm. Wavelengths less than 320 nm, i.e., the UV-B region of from 290 to 320 nm and the UV-C region of less than 290 nm, are substantially, if not completely absorbed by atmospheric ozone (O₃) and oxygen (O₂). As absorption by atmospheric ozone begins at about 350 nm, exposure to UV radiation having a wavelength of less than about 350 nm is generally negligible, and, thus, is not a concern. Therefore, an inexpensive coating for glass that absorbs UV radiation at those wavelengths where exposure is most likely and is readily applied would be desirable.

It is also known that a reduction in the friction between articles on a production line and portions of the line is desirable to reduce jamming and energy costs. Glass bottles and containers are often coated with polyethylene to reduce the coefficient of friction of the surface of the glass. However, as polyethylene and glass do not have a high affinity, the surface is typically first etched with an acid, such as hydrofluoric acid (HF), and then sprayed with polyethylene. As HF and similar acids are highly corrosive and poisonous, the etching process is dangerous, and results in waste disposal problems.

Therefore, simple coating methods of coating glass and metal containers without the need to etch the surface with corrosive materials is needed. The present invention provides such methods.

### SUMMARY OF THE INVENTION

The present invention is directed to a process for making thermoplastic resin coated metal, ceramic, and glass articles. The process of the invention comprises providing a metal, ceramic, or glass article, applying an aqueous solution, suspension, and/or dispersion of a coating material comprising a first thermoplastic resin to at least a portion of a coated or uncoated surface, preferably an outer surface, of the article substrate by dip, spray, or flow coating, withdrawing the article from the dip, spray, or flow coating at a rate that forms a first coherent film, and removing any excess material resulting from the dip, spray, or flow coating, preferably by at least one of rotation, gravity, a wiper, a brush, an air knife, and air flow. The coated article is then cured and/or dried until the first film is substantially dried to form a first coating. Surface preparation, such as etching, is not required before applying the coating with the method of the invention. The first thermoplastic resin comprises a thermoplastic epoxy resin, and, preferably, the article comprises a container. At least one additional coating may be applied to the article, which is preferably, but need not be, a thermoplastic resin, and, more preferably, a thermoplastic epoxy resin. The additional coating may be applied either prior to or after the application of the first thermoplastic resin coating. Any number of coating layers may be applied, where the preferred number is 1 to about 3. Preferably at least one coating layer is at least partially cross-linked to provide resistance to at least one of chemical and mechanical abuse. Also, at least one additive may be mixed with at least one coating material to provide at least one of improved ultraviolet protection, scuff resistance, blush resistance, chemical resistance, and a reduced coefficient of friction to a surface of the article.

### BRIEF DESCRIPTION OF THE DRAWINGS

FIG. 1 illustrates a container coated in accordance with the invention;

FIG. 2 is a cross-sectional illustration of the coated container of FIG. 1;

FIG. 3 is a perspective view of a can coated in accordance with the invention;

FIG. 4 is an enlarged illustration of a cross-section of the body portion of a container coated in accordance with the invention;

FIG. 5 is a flow diagram of a coating process in accordance with the invention;

FIG. 6 is a flow diagram of a process in accordance with the invention in which the system comprises a single coating unit;

FIG. 7 is a flow diagram of a process in accordance with the invention in which the system comprises multiple coating units in a single integrated system;

FIG. 8 is a flow diagram of a process in accordance with the invention in which the system comprises multiple coating units in a modular system.

### DETAILED DESCRIPTION OF THE PREFERRED EMBODIMENTS

The present invention is directed to methods for applying one or more layers of a coating material to at least a portion of a surface of glass, ceramic, or metal articles. Preferably, the surface is compatible with the coating material to allow at least a portion of the surface to be coated with the method of the invention. An advantage of the invention is that no surface preparation of the article, such as etching, particularly with hydrofluoric acid, is required. In particular, articles coated with the methods of the inventions, particularly glass surfaces, do not require etching with hydrofluoric acid prior to applying a coating, as is required in prior art methods. Preferably, the articles are bottles, jars, cans, tubs, or trays for foods and beverages, where cans and bottles are most preferred. The coating material preferably comprises one or more thermoplastic materials and, optionally, one or more additives to produce layers providing at least one of improved ultraviolet (“UV”) protection, scuff resistance, blush resistance, and chemical resistance. Preferably, the coating material is selected to provide good adhesion to the substrate or any intervening layer, reducing the potential for any significant delamination. Layers of materials other than thermoplastic materials may be used with the invention, as long as the resulting coated article comprises at least one layer comprising a thermoplastic material that has been applied with the method of the invention.

The method of the invention may also be used to reduce the coefficient of friction of the surface of an article relative to its uncoated surface. As used herein, the term “UV protection layer” refers to a layer that increases the overall UV absorption of the article to which it is applied, and, preferably, has a higher UV absorption coefficient than the article substrate. Also, as used herein, the term “substrate” refers to the material used to form the base article that is coated. Preferably, the coated article is a glass jar or metal can for storing a beverage or food product.

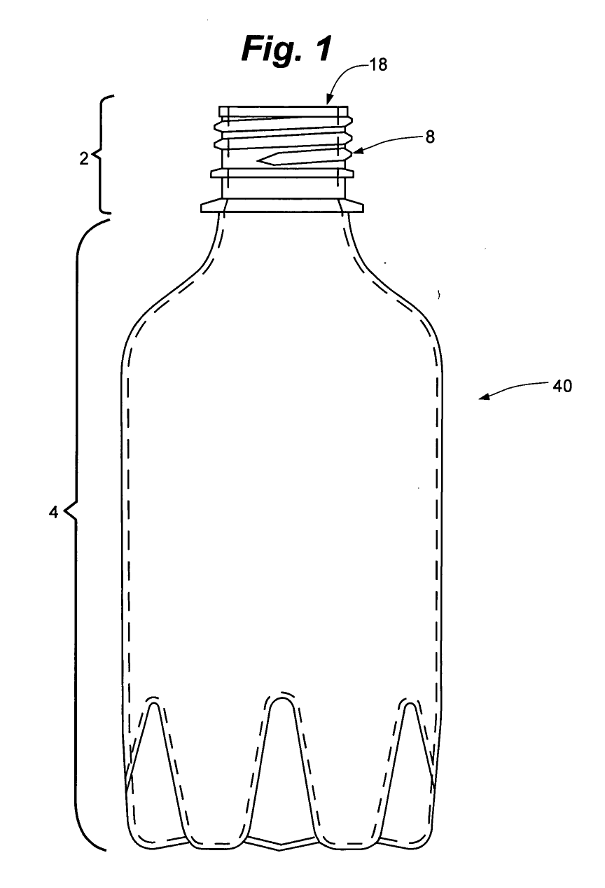

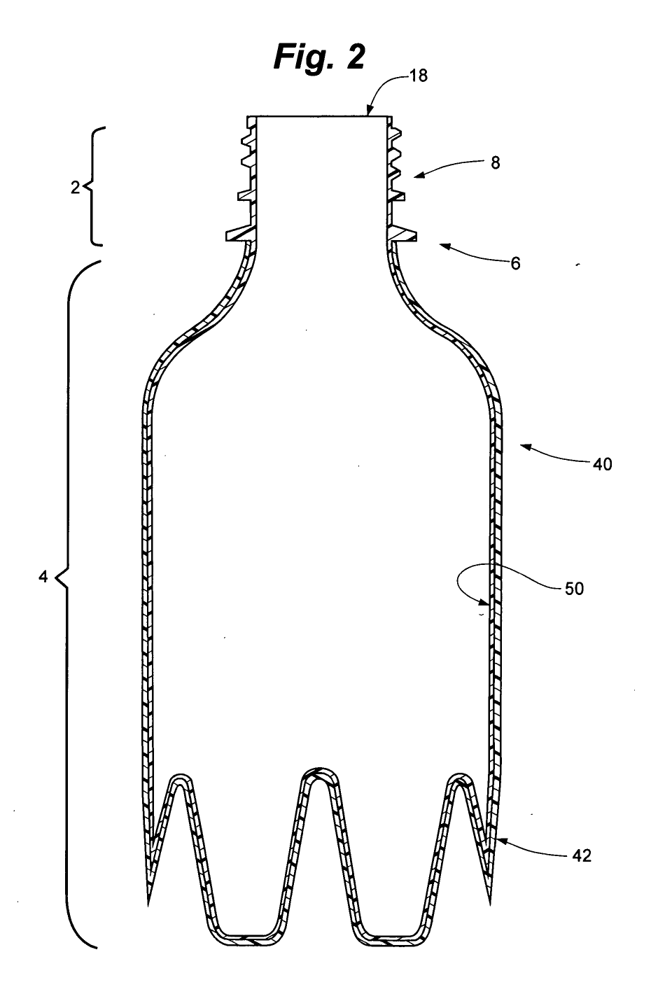

A representative coated container 40, i.e., a bottle, in accordance with the invention is illustrated in FIG. 1 and in cross-section in FIG. 2. The container 40 comprises a neck 2, a body 4, and an outer coating 42. The neck 2 defines an opening 18 for introducing and removing the contents (not shown) of the container 40. As illustrated, the neck 2 further comprises threads 8 for attaching a closure (not shown) to seal the container 40. However, any other closure means known in the art, such as a lip for attaching a cap, may be used. The outer coating layer 42, as illustrated, covers the entire body 4 of the container 40, but does not extend into the neck. However, as will be recognized by those skilled in the art, the coating layer 42 may extend to the threads and, when the coating material is approved by the FDA for contact with food and beverages, to the interior 50 of the container 40. Although the container 40 is illustrated as a bottle, coated containers in accordance with the invention may be any type container known in the art, such as a wide-mouth jar or a can.

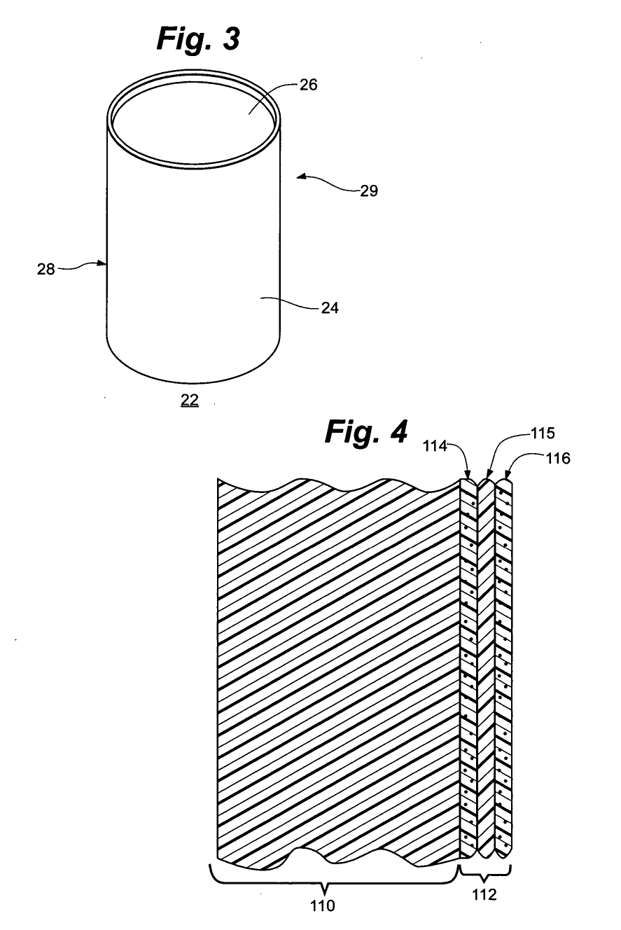

A can 22, coated with a coating 28 in the manner of the container 40 is illustrated in FIG. 3. The coated can 22 comprises a body 24 and a top 26 that may, but need not, comprise a means for opening the can 22. As illustrated, the coating 28 covers the entire outer surface 29 of the can 22, including that of the top 26. However, the top 26 need not be coated in all applications.

FIG. 4 illustrates a cross-section of a portion of the body of a container in accordance with the invention, such as body 4 of the container 40 or the body 24 of the can 22. The illustrated glass, ceramic, or metal substrate 110 is coated with a multilayer coating 112, and comprises an inner layer 114, a central layer 115, and an outer layer 116. Preferably, the material of the inner layer 114 is compatible with the substrate 110, such that the inner layer 114 adheres to the substrate 110 without delaminating or developing any other visible flaw. Although the coating 112, as illustrated, comprises three layers, any number of layers, including as few as one, fall within the scope of the present invention. The thickness of any of the layers 114, 115, and 116 and the substrate 110 can vary, depending on the end use of the container 40 or can 22. Also, the layers may all be formed from the same or different materials. For example, as illustrated in FIG. 4, the inner layer 114 and the outer layer 116 may be the same, and the central layer 115 may be formed from a second material.

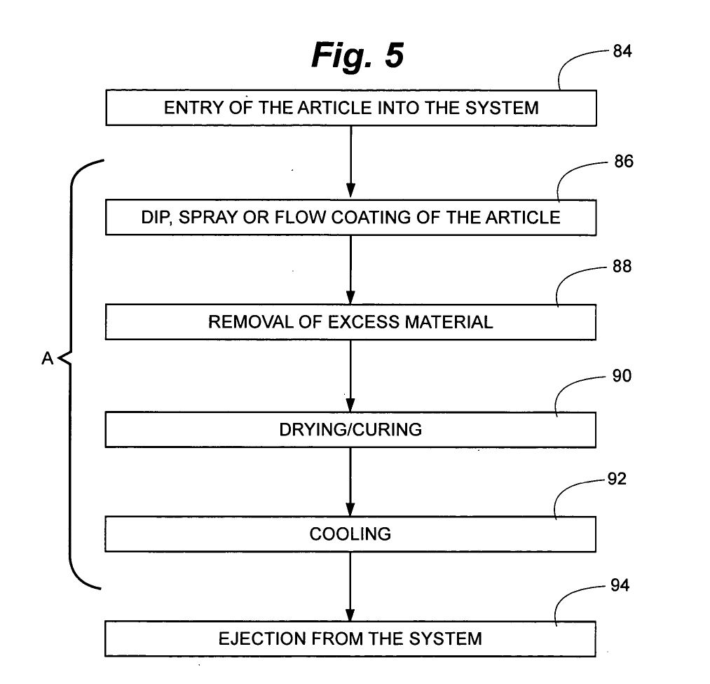

FIG. 5 is a non-limiting flow diagram, illustrating a process and apparatus of the invention. In the process and apparatus of FIG. 5, the article is introduced into the system 84, then dip, spray, or flow coated 86, and excess material is removed 88. The article is then dried and/or cured 90, cooled 92, and ejected from the system 94.

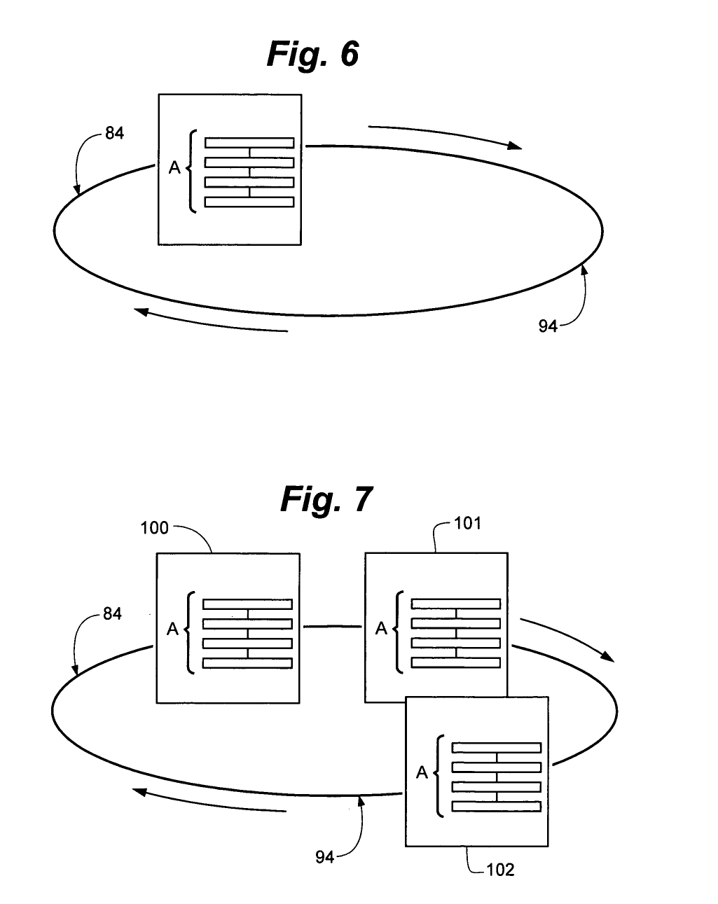

FIG. 6 is a non-limiting flow diagram of a further preferred process of the invention in which the system comprises a single coating unit, A, of the type in FIG. 5 for producing a single layer coating on the article. The article enters the system at 84 prior to the coating unit and exits the system at 94 after leaving the coating unit.

FIG. 7 is a non-limiting flow diagram of an embodiment of the invention in which the system comprises a single integrated processing line that contains multiple stations 100, 101, 102, in which the article is coated, dried, and cured, producing multiple coating layers on the article. The article enters the system at 84 prior to the first coating unit 100, and exits the system at 94 after the last coating unit 102. The illustrated process comprises a single integrated processing line with three coating units. However, it will be understood that the number of coating units may be greater than or less than the number illustrated.

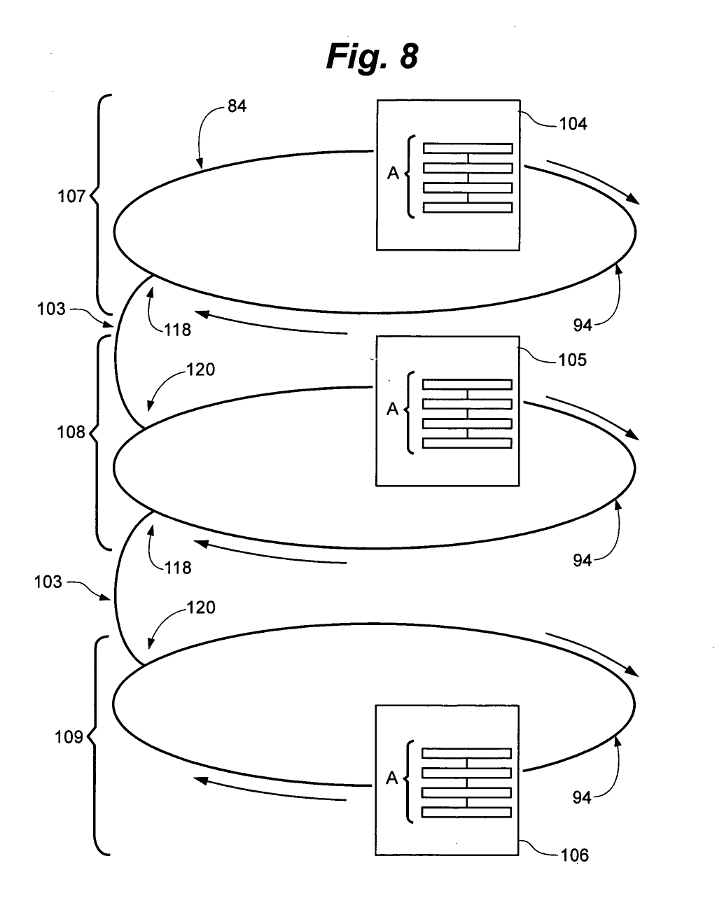

FIG. 8 is a non-limiting flow diagram of a further embodiment of the process of the invention in which the system is modular, such that each processing line 107, 108, 109 is self-contained with the ability to handoff an article to another line 103. This process provides single or multiple coatings depending on the number of connected modules, and, thus, provides maximum flexibility. The article first enters the system at any of several points in the system at 84 or 120. The article can enter at point 84 and proceed through the first module 107. The article may then exit the system at 94, or exit the module at 118, and continue to the next module 108 through a hand off mechanism 103 of any type known in the art. The article then enters the next module 108 at 120. The article may then continue on to the next module 109 or exit the system at any module at 94. The number of modules may be varied depending on the production circumstances required. Further the individual coating units 104, 105, 106 may comprise different coating materials and techniques depending on the requirements of a particular production line. The interchangeability of different modules and coating units provides for maximum flexibility. The preferred methods and apparatus for making coated articles in accordance with the invention are set forth in more detail below.

For glass and transparent ceramic substrates, the coating materials are preferably amorphous rather than crystalline to retain the transparency of the substrate. Preferred coating materials preferably have sufficient tensile strength so they may act as a structural component of the container, allowing the coating material to displace some of the substrate in the container without sacrificing container performance.

For applications where optical clarity is important, preferred coating materials have an index of refraction similar to that of the substrate. When the refractive index of the substrate and the coating material are similar, the containers are optically clear, and, thus, cosmetically appealing, for use as a beverage or food container where clarity of the bottle is frequently desired. Where two materials having substantially dissimilar refractive indices are placed in contact with each other, the resulting combination may produce visual distortions, such that the container appears cloudy or opaque, depending upon the degree of difference in the refractive indices of the materials.

Glass has an index of refraction for visible light within the range of about 1.5 to about 1.7, depending upon its type and physical configuration. When made into containers, the refractive index is preferably within the range of about 1.52 to about 1.66, and, more preferably, in the range of about 1.52 to about 1.6. Using the designation nᵢ to indicate the refractive index for glass and nₒ to indicate the refractive index for the coating material, the ratio between the values nᵢ and nₒ is preferably about 0.8 to about 1.3, more preferably, about 1.0 to about 1.2, and, most preferably, about 1.0 to about 1.1. As will be recognized by those skilled in the art, for the ratio nᵢ/nₒ=1, the distortion due to refractive index will be minimized if not eliminated, because the two indices are identical. As the ratio progressively varies from one, the distortion tends to increase.

In a preferred embodiment, the coating materials comprise thermoplastic epoxy resins (TPEs). A further preferred embodiment includes “phenoxy” resins which are a subset of thermoplastic epoxy resins. Phenoxy resins, as that term is used herein, include a wide variety of materials including those discussed in WO 99/20462, also published as U.S. Pat. No. 6,312,641. A further subset of phenoxy resins and thermoplastic epoxy resins are the preferred hydroxy-phenoxyether polymers, where polyhydroxyaminoether copolymers (PHAE) is highly preferred. See, e.g., U.S. Pat. Nos. 6,011,111; 5,834,078; 5,814,373; 5,464,924; 5,275,853; and PCT Application Nos. WO 99/48962; WO 99/12995; WO 98/29491; and WO 98/14498.

Preferably, the thermoplastic epoxy resins, more specifically the phenoxy resins, used as coating materials in the present invention comprise one of the following types:

(1) hydroxy-functional poly(amide ethers) having repeating units represented by any one of the Formulae Ia, Ib or Ic: 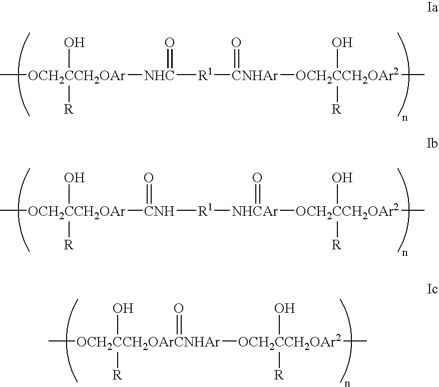
(2) poly(hydroxy amide ethers) having repeating units represented independently by any one of the Formulae IIa, IIb or IIc: 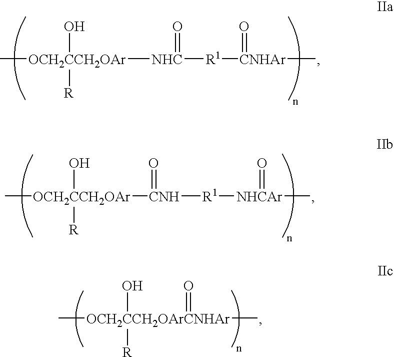
(3) amide- and hydroxymethyl-functionalized polyethers having repeating units represented by Formula III: 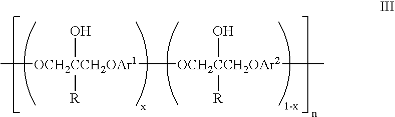
(4) hydroxy-functional polyethers having repeating units represented by Formula IV: 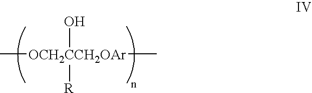
(5) hydroxy-functional poly(ether sulfonamides) having repeating units represented by Formulae Va or Vb: 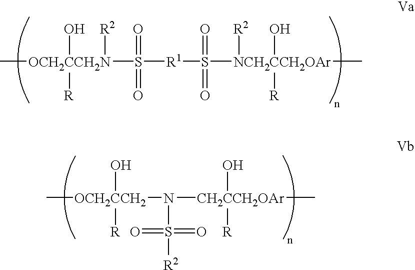
(6) poly(hydroxy ester ethers) having repeating units represented by Formula VI: 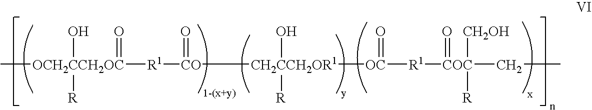
(7) hydroxy-phenoxyether polymers having repeating units represented by Formula VII: 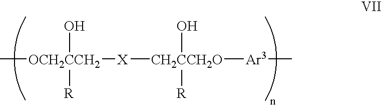
and
(8) poly(hydroxyamino ethers) having repeating units represented by Formula VIII: 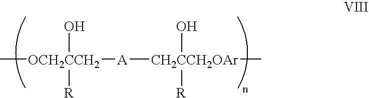
where each Ar individually represents a divalent aromatic moiety, substituted divalent aromatic moiety or heteroaromatic moiety, or a combination of different divalent aromatic moieties, substituted aromatic moieties or heteroaromatic moieties; R is individually hydrogen or a monovalent hydrocarbyl moiety; each Ar₁ is a divalent aromatic moiety or combination of divalent aromatic moieties bearing amide or hydroxymethyl groups; each Ar₂ is the same or different than Ar and is individually a divalent aromatic moiety, substituted aromatic moiety or heteroaromatic moiety or a combination of different divalent aromatic moieties, substituted aromatic moieties or heteroaromatic moieties; R₁ is individually a predominantly hydrocarbylene moiety, such as a divalent aromatic moiety, substituted divalent aromatic moiety, divalent heteroaromatic moiety, divalent alkylene moiety, divalent substituted alkylene moiety or divalent heteroalkylene moiety or a combination of such moieties; R₂ is individually a monovalent hydrocarbyl moiety; A is an amine moiety or a combination of different amine moieties; X is an amine, an arylenedioxy, an arylenedisulfonamido or an arylenedicarboxy moiety or combination of such moieties; and Ar₃ is a “cardo” moiety represented by any one of the Formulae: 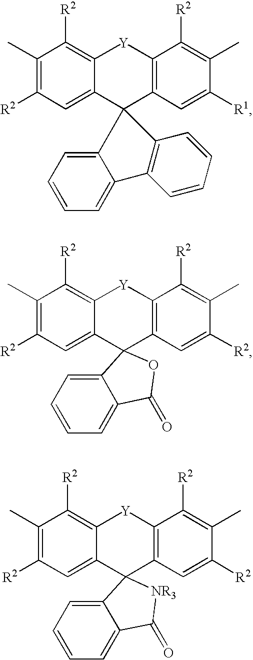
where Y is nil, a covalent bond, or a linking group, where suitable linking groups include, for example, an oxygen atom, a sulfur atom, a carbonyl atom, a sulfonyl group, or a methylene group or similar linkage; n is an integer from about 10 to about 1000; x is 0.01 to 1.0; and y is 0 to 0.5.

The term “predominantly hydrocarbylene” means a divalent radical that is predominantly hydrocarbon, but which optionally contains a small quantity of a heteroatomic moiety, as oxygen, sulfur, imino, sulfonyl, sulfoxyl, and the like.

The hydroxy-functional poly(amide ethers) represented by Formula I are preferably prepared by contacting an N,N′-bis(hydroxyphenylamido)alkane or arene with a diglycidyl ether, as disclosed in U.S. Pat. Nos. 5,089,588 and 5,143,998.

The poly(hydroxy amide ethers) represented by Formula II are prepared by contacting a bis(hydroxyphenylamido)alkane or arene, or a combination of 2 or more of these compounds, such as N,N′-bis(3-hydroxyphenyl) adipamide or N,N′-bis(3-hydroxyphenyl)glutaramide, with an epihalohydrin, as disclosed in U.S. Pat. No. 5,134,218.

The amide- and hydroxymethyl-functionalized polyethers represented by Formula III can be prepared, for example, by reacting the diglycidyl ethers, such as the diglycidyl ether of bisphenol A, with a dihydric phenol having pendant amido, N-substituted amido and/or hydroxyalkyl moieties, such as 2,2-bis(4-hydroxyphenyl)acetamide and 3,5-dihydroxybenzamide. These polyethers and their preparation are disclosed in U.S. Pat. Nos. 5,115,075 and 5,218,075.

The hydroxy-functional polyethers represented by Formula IV can be prepared, for example, by allowing a diglycidyl ether or combination of diglycidyl ethers to react with a dihydric phenol or a combination of dihydric phenols using the process disclosed in U.S. Pat. No. 5,164,472. Alternatively, the hydroxy-functional polyethers are obtained by allowing a dihydric phenol or combination of dihydric phenols to react with an epihalohydrin by the process disclosed by Reinking, Barnabeo and Hale in the Journal of Applied Polymer Science, Vol. 7, p. 2135 (1963).

The hydroxy-functional poly(ether sulfonamides) represented by Formula V are prepared, for example, by polymerizing an N,N′-dialkyl or N,N′-diaryldisulfonamide with a diglycidyl ether, as disclosed in U.S. Pat. No. 5,149,768.

The poly(hydroxy ester ethers) represented by Formula VI are prepared by reacting diglycidyl ethers of aliphatic or aromatic diacids, such as diglycidyl terephthalate, or diglycidyl ethers of dihydric phenols with, aliphatic or aromatic diacids, as adipic acid or isophthalic acid. These polyesters are disclosed in U.S. Pat. No. 5,171,820.

The hydroxy-phenoxyether polymers represented by Formula VII are prepared, for example, by contacting at least one dinucleophilic monomer with at least one diglycidyl ether of a cardo bisphenol, such as 9,9-bis(4-hydroxyphenyl)fluorene, phenolphthalein, or phenolphthalimidine or a substituted cardo bisphenol, such as a substituted bis(hydroxyphenyl)fluorene, a substituted phenolphthalein or a substituted phenolphthalimidine under conditions sufficient to cause the nucleophilic moieties of the dinucleophilic monomer to react with epoxy moieties to form a polymer backbone containing pendant hydroxy moieties and ether, imino, amino, sulfonamido or ester linkages. These hydroxy-phenoxyether polymers are disclosed in U.S. Pat. No. 5,184,373.

The poly(hydroxyamino ethers) (“PHAE” or polyetheramines) represented by Formula VIII are prepared by contacting one or more of the diglycidyl ethers of a dihydric phenol with an amine having two amine hydrogens under conditions sufficient to cause the amine moieties to react with epoxy moieties to form a polymer backbone having amine linkages, ether linkages and pendant hydroxyl moieties. These compounds are disclosed in U.S. Pat. No. 5,275,853. For example, polyhydroxyaminoether copolymers can be made from resorcinol diglycidyl ether, hydroquinone diglycidyl ether, bisphenol A diglycidyl ether, or mixtures thereof.

The phenoxy thermoplastics commercially available from Phenoxy Associates, Inc. are suitable for use in the present invention. These hydroxy-phenoxyether polymers are the condensation reaction products of a dihydric polynuclear phenol, such as bisphenol A, and an epihalohydrin and have the repeating units represented by Formula IV where Ar is an isopropylidene diphenylene moiety. The process for preparing these is disclosed in U.S. Pat. No. 3,305,528, incorporated herein by reference in its entirety.

The preferred TPE coating materials, including phenoxy and PHAE materials, are generally not adversely affected by contact with water, and form stable aqueous solutions, suspensions, and/or dispersions. Preferred coating materials range from about 10 percent solids to about 50 percent solids. Useful polar solvents include, but are not limited to, water, alcohols, and glycol ethers.

A preferred thermoplastic epoxy coating material is a polyhydroxyaminoether copolymer (PHAE), represented by Formula VIII, solution, suspension, and/or dispersion, which, when applied to a container, contains about 10 to about 30 percent solids. A PHAE solution, suspension, and/or dispersion may be prepared by stirring or otherwise agitating the PHAE in a solution of water with an organic acid, such as acetic acid, phosphoric acid, lactic acid, malic acid, citric acid, glycolic acid and/or mixtures thereof, where the preferred organic acids are acetic and phosphoric acids. PHAE solutions, suspensions, and/or dispersions preferably also include organic acid salts produced by the reaction of the polyhydroxyaminoethers with the organic acids discussed above.

One preferred thermoplastic epoxy coating material is a dispersion or solution of polyhydroxyaminoether copolymer (PHAE), represented by Formula VIII. The dispersion or solution, when applied to an article, greatly reduces the permeation rate of a variety of gases through the container walls in a predictable and well known manner. The dispersion or latex made thereof preferably contains 10 to 30 percent solids. A PHAE solution/dispersion may be prepared by stirring or otherwise agitating the PHAE in a solution of water with an acid, preferably acetic or phosphoric acid, but also including lactic, malic, citric, or glycolic acid and/or mixtures thereof. These PHAE solution/dispersions also include acid salts produced by the reaction of the polyhydroxyaminoethers with these acids.

The following PHAE polymers are preferred barrier materials for coating articles, particularly preforms and containers, that can be cured using a catalyst and IR radiation: PHAE materials comprising from about 10 to about 75 mole percent resorcinol copolymerized into the polymer chain, and dispersed in an aqueous medium using at least one of phosphoric acid, lactic acid, malic acid, citric acid, acetic acid, and glycolic acid. PHAE resins based on resorcinol have also provided superior results as a barrier material. Other variations of the polyhydroxyaminoether chemistry may prove useful such as crystalline versions based on hydroquinone diglycidylethers. Partially cross-linked PHAE materials exhibit high chemical resistance, low blushing and low surface tension. The solvents used to dissolve these materials include, but are not limited to, polar solvents such as alcohols, water, glycol ethers or blends thereof. Preferred cross-linkers are based on resorcinol diglycidyl ether (RDGE) and hexamethoxymethylmelamine (HMMM).

Examples of preferred copolyester coating materials and a process for their preparation is disclosed in U.S. Pat. No. 4,578,295 to Jabarin. They are generally prepared by heating a mixture of at least one reactant selected from isophthalic acid, terephthalic acid and their C₁ to C₄ alkyl esters with 1,3 bis(2-hydroxyethoxy)benzene and ethylene glycol. Optionally, the mixture may further comprise one or more ester-forming dihydroxy hydrocarbon and/or bis(4-β-hydroxyethoxyphenyl)sulfone. Especially preferred copolyester coating materials are available from Mitsui Petrochemical Ind. Ltd. (Japan) as B-010, B-030 and others of this family.

Examples of preferred polyamide coating materials include MXD-6 from Mitsubishi Gas Chemical (Japan). Preferred polyamide coating materials preferably comprise about 1 to about 10 percent polyester, and, more preferably, about 1 to about 2 percent polyester by weight, where the polyester is preferably PET, and, more preferably, high IPA PET. These materials are made by adding the polyester to the polyamide polycondensation mixture. “Polyamide”, as used herein, shall include those polyamides containing PET or other polyesters.

Other preferred coating materials include polyethylene naphthalate (PEN), PEN copolyester, and PET/PEN blends. PEN materials can be purchased from Shell Chemical Company.

An advantage of the preferred methods is their flexibility allowing for the use of multiple functional additives. Additives known by those of ordinary skill in the art for their ability to provide enhanced UV protection, scuff resistance, blush resistance, impact resistance and/or chemical resistance, as well as a reduced coefficient of friction, may be used.

Preferred additives are not affected by the chemistry of the coating materials. Further, additives are preferably stable in aqueous conditions. The preferred additives may be prepared by methods known to those of skill in the art. For example, the additives may be mixed directly with a particular coating solution, suspension, and/or dispersion, they may be dissolved/dispersed separately and then added to a particular coating solution, suspension, and/or dispersion, or they may be combined with a particular coating material prior to addition of the solvent that forms the solution, suspension, and/or dispersion. In addition, in some embodiments, the preferred additives may be used alone as a single coating layer.

In preferred embodiments, the properties of the coating may be enhanced by the addition of different additives. In one preferred embodiment, the ability of the coatings to absorb or reflect UV may be enhanced by the addition of different additives. Preferably, the coating provides UV protection at wavelengths to which the article is likely to be exposed. That is, the coating preferably provides protection from about 350 nm to about 400 nm, more preferably, from about 320 to about 400 nm, and, most preferably at all UV wavelengths less than about 400 nm. The UV protection material may be used as an additive with other layers or applied separately as a single coat. Preferably the UV protection material is added in a form that is compatible with aqueous-based solutions, suspensions, and/or dispersions. For example, a preferred UV protection material is Milliken UV390A clear shield. That material is an oily liquid that is first blended into water. The resulting solution, suspension, and/or dispersion is then added to a PHAE, and agitated. The resulting solution contains 10 percent UV390A, and provides UV protection up to 400 nm when applied to a PET container. As previously described, in another embodiment the previous UV390A solution is applied as a single coating.

In another preferred embodiment, a top coat is applied to provide chemical resistance to harsher chemicals. Preferably these top coats are aqueous-based polyesters or acrylics which are optionally partially or fully cross-linked. A preferred aqueous-based polyester is polyethylene terephthalate, however other polyesters may also be used. A preferred aqueous-based acrylic is ICI PXR 14100 Carboxyl Latex.

A preferred aqueous-based polyester resin is disclosed in U.S. Pat. No. 4,977,191 to Salsman, incorporated herein by reference to the extent necessary to describe the resin and how to obtain it. More specifically, the Salsman '191 patent discloses an aqueous-based polyester resin, comprising a reaction product of 20 to 50 percent by weight of waste terephthalate polymer, 10 to 40 percent by weight of at least one glycol and 5 to 25 percent by weight of at least on oxyalkylated polyol.

Another preferred aqueous-based polymer is a sulfonated aqueous-based polyester resin composition, as disclosed in U.S. Pat. No. 5,281,630 to Salsman, which is incorporated by reference herein to the extent necessary to describe the resin composition and how to obtain it. Specifically, the Salsman '630 patent disclosed an aqueous suspension of a sulfonated water-soluble or water dispersable polyester resin comprising a reaction product of 20 to 50 percent by weight terephthalate polymer, 10 to 40 percent by weight at least one glycol and 5 to 25 percent by weight of at least one oxyalkylated polyol to produce a prepolymer resin having hydroxyalkyl functionality, where the prepolymer resin is further reacted with about 0.10 mole to about 0.50 mole of an α,β-ethylenically unsaturated dicarboxylic acid per 100 g of prepolymer resin. The resulting resin, terminated by a residue of an α,β-ethylenically unsaturated dicarboxylic acid, is reacted with about 0.5 mole to about 1.5 mole of a sulfite per mole of α,β-ethylenically unsaturated dicarboxylic acid residue to produce a sulfonated-terminated resin.

A further preferred aqueous-based polymer is the coating disclosed in U.S. Pat. No. 5,726,277 to Salsman, incorporated herein by reference to the extent necessary to describe the polymer and how to obtain it. Specifically, the Salsman '277 patent discloses coating compositions comprising a reaction product of at least 50 percent by weight of waste terephthalate polymer and a mixture of glycols, including an oxyalkylated polyol, in the presence of a glycolysis catalyst, where the reaction product is further reacted with a difunctional organic acid, and the weight ratio of acid to glycols in is the range of 6:1 to 1:2.

Similarly, U.S. Pat. No. 4,104,222 to Date, et al., incorporated herein by reference to the extent necessary to describe the disclosed dispersion and how to obtain it, discloses a dispersion of a linear polyester resin obtained by mixing a linear polyester resin with a higher alcohol/ethylene oxide addition type surface-active agent, melting the mixture, and dispersing the resulting melt by pouring it into an aqueous solution of an alkali under stirring. In particular, this dispersion is obtained by mixing a linear polyester resin with a surface-active agent of the higher alcohol/ethylene oxide addition type, melting the mixture, and dispersing the resulting melt by pouring it into an aqueous solution of an alkanolamine under stirring at a temperature of 70° to 95° C., where the alkanolamine is selected from the group consisting of monoethanolamine, diethanolamine, triethanolamine, monomethylethanolamine, monoethylethanolamine, diethylethanolamine, propanolamine, butanolamine, pentanolamine, N-phenylethanolamine, and an alkanolamine of glycerin, and is present in the aqueous solution in an amount of 0.2 to 5 weight percent. The surface-active agent of the higher alcohol/ethylene oxide addition type is an ethylene oxide addition product of a higher alcohol, having an alkyl group of at least 8 carbon atoms, and an alkyl-substituted phenol or a sorbitan monoacylate, where the surface-active agent has an HLB value of at least 12.

U.S. Pat. No. 4,528,321 to Allen discloses a dispersion in a water immiscible liquid of water soluble or water swellable polymer particles that has been made by reverse phase polymerization in the water immiscible liquid, and includes a non-ionic compound selected from C₄₋₁₂ alkylene glycol monoethers and their C₁₋₄ alkanoates and C₆₋₁₂ polyalkylene glycol monoethers and their C₁₋₁₄ alkanoates.

The coating materials may be at least partially cross-linked to enhance thermal stability of coatings for hot fill applications. Inner layers may comprise low cross-linking materials while outer layers may comprise high cross-linking materials or other suitable combinations. For example, the inner coating on the PET surface may utilize non- or low-cross-linked material, as the the BLOX® 599-29, and the outer coat may utilize material, such as EXP 12468-4B, capable of cross-linking to ensure maximum adhesion to the PET.

The present invention provides the ability to handle many types of additives and coatings in an aqueous-based system, making the present invention easy to use and economical as compared to other systems. For example, as the present invention is aqueous-based, there is no need for expensive systems to handle VOCs used in other systems, such as epoxy thermosets. In addition, upon contact with human skin, most of the solvents do not cause irritation, allowing for ease of use in manufacturing.

Generally, preferred articles used herein are containers with one or more coating layers. The coating layer provides additional functionality, such as UV protection, impact resistance, scuff resistance, blush resistance, chemical resistance, a reduction in the surface coefficient of friction, and the like. The layers may be applied as multiple layers, each layer having one or more functional characteristics and may have varying thicknesses, for example, each successive layer of coating material being thinner, or as a single layer containing one or more functional components.

The inner layer is preferably a primer or base coat having functional properties for enhanced adhesion to glass, metal, or ceramic and UV resistance, and the outer coatings provide at least one of scuff resistance and a reduced coefficient of friction. Preferably, the outer layer comprises a partially or highly cross-linked material to provide a hard increased cross-linked coating. The final coating and drying of the container provides scuff resistance to the surface of the container, as the solution, suspension, and/or dispersion preferably contains a diluted or suspended paraffin or other wax, slipping agent, polysilane or low molecular weight polyethylene.

Once suitable coating materials are chosen, the container is preferably coated in a manner that promotes adhesion between the two materials. Generally, adherence between coating materials and the container substrate increases as the surface temperature of the container increases. Therefore it is preferable to perform coating on a heated container, although the preferred coating materials will adhere to the container at room temperature.

Containers may have static electricity that results in the containers attracting dust and getting dirty quickly. In a preferred embodiment the containers are taken directly from the production line, and coated while still warm. By coating the containers immediately after they are removed from the production line, the dust problem is reduced or eliminated, and, it is believed, the warm containers enhance the coating process. However, the containers may be stored prior to coating, preferably in a manner that keeps the containers substantially clean.

Preferably, the coating process is performed on an automated system in which the article enters the system, the article is dip, spray, or flow coated, excess material is removed, and the coated article is dried and/or cured, cooled, and ejected from the system. In one embodiment the apparatus is a single integrated processing line that contains two or more dip, spray, or flow coating units and two or more curing and/or drying units that produce a container with multiple coatings. In another embodiment, the system comprises one or more coating modules. Each coating module comprises a self-contained processing line with one or more dip, spray, or flow coating units and one or more curing and/or drying units. Depending on the module configuration, a container may receive one or more coatings. For example, one configuration may comprise three coating modules where the container is transferred from one module to the next, in another configuration, the same three modules may be in place but the container is transferred from the first to the third module, skipping the second. This ability to switch between different module configurations provides maximum flexibility.

A preferred, fully automated embodiment of the present invention operates as follows: Articles, such as metal, ceramic, or metal containers are introduced into the system without any prior alteration. Preferably the articles are at a temperature of from about 100° F. to about 130° F. (about 37° C. to about 55° C.), more preferably, about 120° F. (about 50° C.), when introduced into the system, and are at least relatively clean, although cleaning is not necessary.

Suitable coating materials may be prepared and used with any of dip, spray, or flow coating, and are substantially the same for each coating method. The coating material is dissolved and/or suspended in one or more solvents to form a solution, suspension, and/or dispersion. The temperature of the coating solution, suspension, and/or dispersion is adjusted to provide the desired viscosity for the application and coating. That is, if a lower viscosity is required, typically, but not necessarily always, the temperature is increased, and, if a higher viscosity is required, the temperature typically, but not necessarily always, is lowered. An increase in the viscosity also increases the deposition rate, and, thus, the temperature can be used to control the deposition. Preferably the temperature of a solution, suspension, and/or dispersion ranges from about 60° F. to about 80° F. (about 15° C. to about 27° C.), more preferably, about 70° F. (about 21° C.). The solution, suspension, and/or dispersion is maintained at a temperature below which the material will cure in the holding tank, and, thus, the maximum temperature is preferably less than about 80° F. (about 27° C.). In addition, at temperatures below about 50° F. (about 10° C.), certain solutions, suspensions, and/or dispersions may become too viscous for use in dip, spray, or flow coating. In preferred embodiments, a temperature control system is used to ensure constant temperature of the coating solution, suspension, and/or dispersion. In certain embodiments, as the viscosity increases, additional water may be used to decrease the viscosity of the solution, suspension, and/or dispersion. Other embodiments may also include a water content monitor and/or a viscosity monitor.

In a preferred embodiment, the solution, suspension, and/or dispersion is at a suitable temperature and viscosity to deposit from about 0.05 to about 0.75 grams of coating material per container, and, more preferably, from about 0.15 to about 0.5 grams per container. However, any useful and/or desired amount of material may be applied. Articles comprising about 0.1, 0.2, 0.25, 0.3, 0.35, 0.4, 0.45, 0.55, 0.6, 0.65 and 0.70 grams per article are contemplated in the invention.

A coated bottle of the invention, coated using dip, spray, and/or flow coating, is illustrated in FIGS. 1 to 3. The coating 22 is disposed on the body portion 4 of the container and does not coat the neck portion 2. The interior of the coated container 16 is preferably not coated, but may be coated with a material approved by the FDA for contact with food and beverages. In a preferred embodiment this is accomplished through the use of a holding mechanism comprising an expandable collet that is inserted into the container combined with a housing surrounding the outside of the neck portion of the container. The collet expands thereby holding the container in place between the collet and the housing. The housing covers the outside of the neck including the threading, thereby protecting the inside of the container, as well as the neck portion from coating.

Coated containers produced from dip, spray, or flow coating produce a finished product with substantially no distinction between layers. Further, the amount of coating material required to thoroughly coat the container decreases with each successive layer.

In the dip coating process, the containers are dipped into a tank or other suitable container that contains the coating material. This may be accomplished manually, using a retaining rack or the like, or it may be done by a fully automated process. Preferably, the containers are rotated as they are dipped into the coating material. For a 1 inch diameter article, the container is preferably rotated at a speed of about 30 to 80 rpm, more preferably, about 40 rpm to about 70 rpm, and, most preferably, from about 50 to about 60 rpm. This allows for thorough coating of the container. As will be recognized by those of skill in the art, the speed of rotation is preferably slower for larger objects, as the circumference to the object, and, thus, the speed of the surface through the solution, suspension, and/or dispersion, is proportional to its diameter. For example, where the diameter is doubled, the rotational speed should be decreased by a factor of 2. The container is preferably dipped for a period of time sufficient to allow for complete coverage of the article. Generally, only about 0.25 to about 5 seconds is required, although longer and shorter periods may be used, depending upon the application. Longer residence, time does not appear to provide any added coating benefit.

In determining the dipping time and therefore speed, the turbidity of the coating material should also be considered. If the container is dipped too quickly, the coating material may become wavelike and splatter causing coating defects. In addition, many coating material solutions and dispersions form foam and/or bubbles, which can interfere with the coating process. To reduce or eliminate foaming and/or bubbles, the dipping speed is preferably adjusted such that excessive agitation of the coating material is avoided. If necessary, anti-foam/bubble agents may be added to the coating solution, suspension, and/or dispersion.

In a spray process, the articles are sprayed with a coating material provided from a tank or other suitable container containing a solution, suspension, and/or dispersion of the coating material. As with dipping, spraying of containers with the coating material can be done manually on a retaining rack or the like, or it may be done by a fully automated process. Similarly, the articles are preferably rotated while they are sprayed with the coating material. Again, a 1 inch diameter article is preferably rotated at a speed of about 30 to 80 rpm, more preferably, about 40 rpm to about 70 rpm, and, most preferably, from about 50 rpm to about 60 rpm, where the rotational speed for larger diameters is proportionally slower. This allows for thorough coating of the container. The rotational speed should be adjusted to account for the diameter of larger containers.

The container is preferably sprayed for a period of time sufficient to allow for thorough coverage of the container. Generally, about 0.25 to about 5 seconds is sufficient, although longer or shorter times may be required, depending on the container and the coating material. It appears that a longer residence time does not provide any additional benefit.

The properties of the coating material should be considered in determining the spraying time, nozzle size and configuration, and the like. If the spraying rate is too high and/or the nozzle size incorrect, the coating material may splatter causing coating defects. If the speed is too slow and/or the nozzle size incorrect, the resulting coating may be thicker than desired. As with dipping, foaming and/or bubbles can also interfere with the coating process, but may be avoided by selecting the spraying speed, nozzle, and fluid connections to avoid excessive agitation of the coating material. If necessary, anti-foam/bubble agents may be added to the coating solution, suspension, and/or dispersion.

In a flow coating process, a sheet of material, similar to a falling shower curtain or waterfall, through which the container passes through for a thorough coating is preferably provided. Preferably, flow coating occurs with a short residence time of the container in the coating material. The container need only pass through the sheet a period of time sufficient to coat the surface of the container. Again, a longer residence time does not provide any additional benefit for the coating. In order to provide an even coating, the container is preferably rotated while it proceeds through the sheet of coating material. Again, a 1 inch container is preferably rotated at a speed of about 30 to 80 rpm, more preferably, about 40 rpm to about 70 rpm, and, most preferably, from about 50 rpm to about 60 rpm, where the rotational speed for larger diameters is proportionally slower. More preferably, the container is rotating and placed at an angle while it proceeds through the coating material sheet. The angle of the container is preferably acute to the plane of the coating material sheet. This advantageously allows for thorough coating of the container without coating the neck portion or inside of the container.

The coating material is contained in a tank or other suitable container in fluid communication with the production line in a closed system, and is preferably recycled to prevent the waste of any unused coating material. This may be accomplished by returning the flow stream to the coating material tank, but should be done in a manner that avoids foaming and the formation of bubbles, which can interfere with the coating process. The coating material is preferably removed from the bottom or middle of the tank to prevent or reduce the foaming and bubbling. Additionally, it is preferable to decelerate the material flow prior to returning to the coating tank to further reduce foaming and/or bubbles. This can be done by means known to those of skill in the art. If necessary, at least one anti-foaming agent may be added to the coating solution, suspension, and/or dispersion.

In choosing the proper flow rate of coating materials, several variables should be considered to provide proper sheeting, including flow rate velocity, length and diameter of the container, line speed and container spacing. The flow rate determines the accuracy of the sheet of material. If the flow rate is too fast or too slow, the material may not accurately coat the containers. When the flow rate is too fast, the material may splatter and overshoot the production line, causing incomplete coating of the container, waste of the coating material, and increased foaming and/or bubble problems. If the flow rate is too slow, the coating material may only partially coat the container.

The length and the diameter of the container to be coated should also be considered when choosing a flow rate. The sheet of material should thoroughly cover the entire container, therefore flow rate adjustments may be necessary when the length and diameter of containers are changed.

Another factor to consider is the spacing of the containers on the line. As the containers are run through the sheet of material, a so called wake effect may be observed. If the next container passes through the sheet in the wake of the prior container it may not receive a proper coating. Therefore it is important to monitor the speed and center line of the containers. The speed of the containers will be dependent upon the throughput of the specific equipment used.

Advantageously, the preferred methods provide a sufficiently efficient deposition of material that there is virtually no excess material that requires removal. However, in certain applications, it may be necessary to remove excess coating material after the container is coated by any of the dip, spray or flow methods. Preferably, the rotational speed and gravity will normalize the sheet on the container, and remove any excess material. If the holding tank for the coating material is positioned in a manner that allows the container to pass over the tank after coating, the rotation of the container and gravity should cause some excess material to drip off of the container back into the coating material tank. This allows the excess material to be recycled without any additional effort. If the tank is situated in a manner where the excess material does not drip back into the tank, other suitable means of catching the excess material and returning it to be reused may be employed.

Where the above methods are impractical due to production circumstances or insufficient, various methods and apparatus known to those skilled in the art may be used to remove the excess material. For example, a wiper, brush, air knife or air flow may be used alone or in combination. Further, any of these methods may be combined with the rotation and gravity method described above. Preferably any excess material removed by these methods is recycled for further use.

After the container has been coated and any excess material removed, the coated container is then dried and/or cured. The drying and curing process is preferably performed by infrared (IR) heating. In one test of the invention, a 1000 W General Electric Q1500 T3/CL Quartzline Tungsten-Halogen quartz IR lamp was used as the IR source. Equivalent sources may be purchased commercially from any of a number of sources, such as General Electric and Phillips. The source may be used at full or reduced capacity, preferably from about 50 percent to about 90 percent of maximum power, and, more preferably, from about 65 to about 75 percent. Lamps may be used alone or in combination at full or partial power. For example, six IR lamps have been used at about 70 percent capacity.

In addition, the use of infrared heating allows for the thermoplastic epoxy coating, such as PHAE, to dry without overheating the substrate. It has also been found that use of IR heating can reduce blushing and improve chemical resistance. An IR radiation absorbing additive, such as carbon black, may also may be incorporated into the coating composition to enhance and improve the curing process. The additive may be incorporated into the coating composition in any amount that increases absorption of IR radiation without discoloring the finished article.

Although curing and/or drying may be performed without additional air, IR heating is preferably combined with forced air. The air used may be at any useful temperature. The combination of IR and air curing provides the unique attributes of superior chemical, blush, and scuff resistance of preferred embodiments. Further, without wishing to be bound to any particular theory, it is believed that the coating's chemical resistance is a function of cross-linking and curing. The more thorough the curing, the greater the chemical and scuff resistance.

In determining the length of time necessary to thoroughly dry and cure the coating, several factors, such as coating material, thickness of deposition, and container substrate, should be considered. Different coating materials cure at different rates. In addition, as the degree of solids increases, the cure rate decreases. Generally, for containers with about 0.05 to about 0.75 grams of coating material, the curing time is about 10 to 120 seconds, although longer and shorter times may be required depending on the size of the container, the thickness of the coating, and the curing/drying method.

The use of a current of air in addition to IR heating regulates the surface temperature of the container, providing flexibility in the control of the penetration of the radiant heat. If a particular embodiment requires a slower cure rate or a deeper IR penetration, this can be controlled with a current of air, the exposure time to the IR radiation, the IR lamp frequency, or a combination thereof.

Preferably, the container rotates while proceeding through the IR heater. Again, a 1 inch container is preferably rotated at a speed of about 30 to 80 rpm, more preferably, about 40 rpm to about 70 rpm, and, most preferably, from about 50 rpm to about 60 rpm, where the rotational speed for larger diameters is proportionally slower. If the rotation speed is too high, the coating will spatter, causing uneven coating of the container. If the rotation speed is too low, the container will dry unevenly. Gas heaters, UV radiation, flame, and the like may also be employed in addition to, or in lieu of, IR heating.

The container is then cooled in a process that, combined with the curing process, provides enhanced chemical, blush and scuff resistance. It is believed that this is due to the removal of solvents and volatiles after a single coating and between sequential coatings. In one embodiment, the cooling process occurs at ambient temperature. In another embodiment, the cooling process is accelerated by the use of forced ambient or cool air.

Cooling time is also affected by the point in the process where the cooling occurs. In a preferred embodiment multiple coatings are applied to each container. When the cooling step is prior to a subsequent coating, cooling times may be reduced, as elevated container temperature is believed to enhance the coating process. Although cooling times vary, they are generally about 5 to 40 seconds for 24 gram containers with about 0.05 to about 0.75 grams of coating material.

Once the container has cooled it will be ejected from the system and prepared for packaging or handed off to another coating module, where a further coat or coats are applied before ejection from the system.

The various methods and techniques described above provide a number of ways to carry out the invention. Of course, it is to be understood that not necessarily all objectives or advantages described may be achieved in accordance with any particular embodiment described herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

What is claimed is:

1. A process for making a thermoplastic resin coated metal, ceramic, or glass article, the process comprising:
providing a metal, ceramic, or glass article having a substrate;
applying an aqueous solution, suspension, and/or dispersion of a coating material comprising a first thermoplastic resin to at least a portion of a coated or uncoated surface of the article substrate by dip, spray, or flow coating;
withdrawing the article from the dip, spray, or flow coating at a rate so as to form a first coherent film;
removing any excess material resulting from the dip, spray, or flow coating; and
curing and/or drying the coated article until the first film is substantially dried so as to form a first coating.
wherein the first thermoplastic resin comprises a thermoplastic epoxy resin.

2. The process according to claim 1, wherein the article is a container.

3. The process according to claim 1, wherein the removal step comprises at least one of rotation, gravity, a wiper, a brush, an air knife, and air flow.

4. The process according to claim 1, further comprising applying at least one additional coating material to at least a portion of a coated or uncoated surface of the article substrate.

5. The process according to claim 4, wherein the additional coating is a thermoplastic resin.

6. The process according to claim 4, wherein the additional coating is a thermoplastic epoxy resin.

7. The process according to claim 4, wherein the additional coating is added after the application of the first thermoplastic resin coating.

8. The process according to claim 4, wherein the additional coating is added prior to the application of the first thermoplastic resin coating.

9. The process according to claim 4, further comprising applying a third coating to at least a portion of a coated or uncoated surface of the article substrate.

10. The process according to claim 4, further comprising at least partially cross-linking at least a portion of least one coating layer to provide resistance to at least one of chemical and mechanical abuse.

11. The process according to claim 4, further comprising mixing at least one additive with at least one coating material to provide at least one of improved ultraviolet protection, scuff resistance, blush resistance, chemical resistance, and a reduced coefficient of friction to a surface of the article.

12. The process according to claim 1, further comprising mixing at least one additive with the thermoplastic resin to provide at least one of improved ultraviolet protection, scuff resistance, blush resistance, chemical resistance, and a reduced coefficient of friction to a surface of the article.

13. The process according to claim 1, further comprising applying an aqueous solution, suspension, and/or dispersion of a second thermoplastic resin to at least a portion of a coated or uncoated surface of the article substrate by dip, spray, or flow coating;
withdrawing the article from the dip, spray, or flow coating at a rate so as to form a second coherent film;
removing any excess material resulting from the dip, spray, or flow coating; and
curing and/or drying the coated article until the second film is substantially dried so as to form a second coating.

14. The process according to claim 13, wherein the article is a container.

15. The process according to claim 13, wherein the second removal step comprises at least one of rotation, gravity, a wiper, a brush, an air knife, and air flow.

16. The process according to claim 13, further comprising applying a third coating to at least a portion of a coated or uncoated surface of the article.

17. The process according to claim 13, further comprising at least partially cross-linking at least a portion of at least one coating layer to provide resistance to at least one of chemical and mechanical abuse.

18. The process according to claim 3, wherein the removal step further comprises rotation of the article at a speed of about 30 to about 80 rpm.

19. The process according to claim 13, wherein the curing and/or drying steps comprise at least one of infrared heating, forced air, flame curing, gas heaters and UV radiation.

20. The process according to claim 19, further comprising preventing undesirable heating of the article.

21. The process according to claim 13, wherein the curing and/or drying steps comprise infrared heating and forced air.

22. The process according to claim 1, further comprising adding an infrared radiation absorbing additive to the coating material.

23. The process according to claim 1, further comprising rotating the article during at least one of coating and curing and/or drying.

24. The process according to claim 1, wherein the thermoplastic epoxy resin coating comprises at least one phenoxy resin.

25. The process according to claim 24, wherein the phenoxy resin coating comprises at least one hydroxy-phenoxyether polymer.

26. The process according to claim 25, wherein the hydroxy-phenoxyether polymer coating comprises at least one polyhydroxyaminoether copolymer made from resorcinol diglycidyl ether, hydroquinone diglycidyl ether, bisphenol A diglycidyl ether or mixtures thereof.

27. The process according to claim 26, wherein the solution, suspension, and/or dispersion of the thermoplastic epoxy resin comprises at least one organic acid salt formed from the reaction of a polyhydroxyaminoether with at least one of phosphoric acid, lactic acid, malic acid, citric acid, acetic acid, and glycolic acid.

28. The process according to claim 16, wherein the third coating is an acrylic, phenoxy, latex, or epoxy coating that is at least partially cross-linked during the drying process.

29. The process according to claim 13, wherein the article is a container.

30. The process according to claim 1, wherein the article is transparent.

31. An article coated with the process of claim 1.

32. A process for making thermoplastic resin coated metal, ceramic, and glass articles, the process comprising:
providing a metal, ceramic, or glass article;
applying an aqueous solution, suspension, and/or dispersion of a first thermoplastic resin to at least a portion of a coated or uncoated surface of the article substrate by dip, spray, or flow coating;
withdrawing the article from the dip, spray, or flow coating at a rate so as to form a first coherent film;
removing any excess material resulting from the dip, spray, or flow coating;
curing and/or drying the coated article until the first film is substantially dried so as to form a first coating;
applying an aqueous solution, suspension, and/or dispersion of a second thermoplastic resin on the surface of an article substrate by dip, spray, or flow coating;
withdrawing the article from the dip, spray, or flow coating at a rate so as to form a second coherent film;
removing any excess material resulting from the dip, spray, or flow coating; and
curing and/or drying the coated article until the second film is substantially dried so as to form a second coating;
wherein at least one of the first and second thermoplastic resins comprises a thermoplastic epoxy resin.

33. A coated article comprising:
an article body comprising at least one of glass, ceramic, and metal; and
at least one layer comprising a thermoplastic resin coating material disposed on at least a portion of the body; wherein
the layer provides at least one of UV protection, scuff resistance, blush resistance, chemical resistance, and a reduced coefficient of friction.

34. The article according to claim 33, wherein the article is a container.

35. The article according to claim 34, wherein the container is one of a bottle, jar, and can.

36. The article according to claim 33, wherein the coating material of the layer is at least partially cross-linked.

37. The article according to claim 33, further comprising a plurality of layers, wherein each successive layer of coating material is tinner, such that a final layer is thinner than any other layer.

38. The article according to claim 33, wherein the thermoplastic resin coating is a thermoplastic epoxy resin.
